(19) United States
(12) Patent Application Publication
(10) Pub. No.: US 2023/0192434 A1
(43) Pub. Date: Jun. 22, 2023

(54) FIXED DISPENSER FOR PROVIDING ADHESIVE TAPE IN A SAFE WAY IN MASS TRAFFIC SITES

(71) Applicant: Leonardo Perez Gonzalez, Santo Domingo (DO)

(72) Inventor: Leonardo Perez Gonzalez, Santo Domingo (DO)

(21) Appl. No.: 17/553,411

(22) Filed: Dec. 16, 2021

(51) Int. Cl. B65H 35/00; B65H 16/00; B26D 1/02

(52) U.S. Cl. CPC B65H 35/002; B65H 16/005; B26D 1/025; B65H 2402/412; B65H 2701/1944

(57) ABSTRACT

A dispenser for adhesive tape, which is attached to a surface such as a pole, wall, etc. It is useful for providing adhesive tape to a user who wants to be sure that the surface to be touched is clean. This surface can be, for example, a supermarket trolley or anything else with which you do not want to have direct contact.

### FIELD OF THE INVENTION

The invention relates to fixed dispensers of adhesive tape to prevent the user from touching possibly contaminated surfaces.

### BACKGROUND OF THE INVENTION

The prevention of contagions by contact with surfaces is an area of opportunity in pandemic times such as those that are going through, and in the future, as a mechanism to guarantee the hygiene of itinerant users in contact with materials where pathogenic organisms are accommodated and could be dangerous to humans.

Thus, it is noteworthy to mention that there are few solutions in this regard, which are practical and widely used.

For example, there are adhesive tape dispensers, but used for closing boxes or protecting various objects, such as boxes, furniture; where the main purpose is to wrap the objects and not for protecting the user.

On the other hand, there are the self-adhesive tape dispensers, where said material is supplied with the purpose of wrapping food, objects or other things, and which can be fixed or portable.

Examples of this kind of fixed dispensers have been described in the following documents:

U.S. Pat. No. 8,402,872B2, which describes a hybrid towel dispenser, which has a manual and an automatic system to prevent the user from having contact with it. Although its external view is similar to that of the fixed device, the interior has sensors for automatic mode and a dispensing system for manual mode and movement mechanisms for the paper roll with gears and other different components. Therefore, it does not affect the patentability of the present invention, since its distribution and gears are radically different from those of instant invention.

WO2020112073A1 This is a toilet paper dispenser, which comprises a holding mechanism for two tubes on the inside, and on the outside a casing assembly to protect the material against microorganisms. Thus, the general configuration of the device is not similar to that of the present invention, nor its use to dispense adhesive tape for the protection of the user in contact with surfaces.

WO8900968A1 This is a tape dispenser that includes a support for the film roll. The stand includes a handle. Also, a brake roller is supported by the roll holder and engages the peripheral surface of a third roller. This third roller is pushed by some bias springs and the brake roller, restricting its rotation and thus facilitating the stretching of the film when it is removed from said roller. Even when it comes to an adhesive tape dispenser, the internal configuration is different from that of the present invention, since it involves a series of rollers that keep the tape under tension. On the other hand, in the present case, the tape is arranged on a roll holder, without a tension mechanism beyond gravity and also has a security system and a tape cutting system.

U.S. Pat. No. 4,522,338A. This document describes a fixed plastic roll dispenser, comprising two adjacent side members on each side of the roll. These side members have a bearing member disposed thereon to support the core of the roll and to allow the core and roll to rotate during dispensing. The support members can be inserted into the core and have an expandable support surface on which the end of the core can rotate when the surface is rolled. Even though it could be considered that it is a fixed dispenser similar to that of the instant invention, the axis that supports the roll and the global configuration of the present dispenser are far from the invention described in the US patent.

GB2577169A This is a plastic tape dispenser with a portion that holds the dispenser and an extension portion with a free end. The dispenser may be cylindrical and tubular with grooves to elastically adjust its diameter at the distal end. The projections of the extender fit into two pairs of opposing openings in the dispenser to secure it in an extended or retracted position. The general configuration of the dispenser of this British patent does not resemble that of the present invention, since in principle it comprises a shaft where the plastic tape fits, while in the present invention, the adhesive tape is held by the notches sides of the dispenser.

Thus, in light of the state of the art found, the present invention's dispenser differs in that it comprises two pieces, one that is fixed to a surface, such as a wall or a pole, and a removable piece, but in turn attached to the fixed portion, where the fixed portion also has a cutting blade and notches to contain the roll of plastic material. These and other differentiating characteristics will be described below.

### SUMMARY OF THE INVENTION

The present invention describes and claims an adhesive tape dispenser, characterized in that it comprises two pieces, a base (1) and a front cover (2), the base in turn comprises at least one mounting eye (3), useful for fixing the dispenser on the surface of interest, be it a wall or a pole, and that is firmly attached to said surface to prevent breakage or fall due to repeated use; the base comprises an eyelet for securing (4), which will allow the closure of the hinge-type padlock (10), which is located on the front cover (2). The base in turn comprises side walls (5), on the inside of which it has two U-shaped pieces, here called the tube grip (6), which allows an adhesive tape to be attached and can roll to dispense the plastic material, wherein the dispenser further comprises at the base (1) a toothed surface for cutting the adhesive tape (8). Said dispenser is further characterized in that, when the adhesive tape is not coupled to a tube that can be compatible with the gripper (6), it will be provided with a tube that is compatible in shape and size with said gripper (6). Likewise, in a preferred embodiment, the dispenser is further characterized in that a recess (7) is used to couple the base (1) with the front cover (2), which is perfectly adapted to a pivot (12), which is attached from the inside to the projection (11) of the front cover. Likewise, the dispenser is further characterized in that the front cover (2) in turn comprises an eyelet (9), which serves to fix a padlock (10) to prevent its accidental opening or the removal of the adhesive tape. In a further embodiment, the toothed surface for cutting the adhesive tape (8) can be fixed or extruded with the rest of the plastic piece. In another embodiment, the toothed surface for cutting the adhesive tape (8) can be separated so that it can be replaced when the toothed part wears out from everyday use.

Furthermore, a method for dispensing adhesive tape is described, characterized in that it comprises the steps of: introducing adhesive tape into a dispenser such as the one described above, wherein the adhesive tape is extracted from the dispenser by means of mechanical force from the bottom of the device and cut by means of the toothed surface for cutting (8).

Additionally, the dispenser of the present invention is used to provide adhesive tape to a user, wherein said adhesive tape is self-adhesive or said adhesive tape is adhesive; wherein the dispenser is located in a place where the user needs to isolate a potentially contaminated surface; wherein said location is a mass flow location, such as, but not limited to, a supermarket, an airport, or being on a means of transportation.

### BRIEF DESCRIPTION OF THE FIGURES

FIG. 1 shows an exploded-view of the dispenser of the present invention, including all its components;

FIG. 2 shows a view of the toothed portion (20) in one of the preferred embodiments of the invention;

FIG. 3 shows a side view of the dispenser of the present invention;

FIG. 4 shows a detailed view of the tube handle 6, with the preferred embodiment that includes the small brackets (19); and

FIG. 5 shows a complete view of the dispenser of the present invention fully enabled for use.

### DETAILED DESCRIPTION OF THE INVENTION

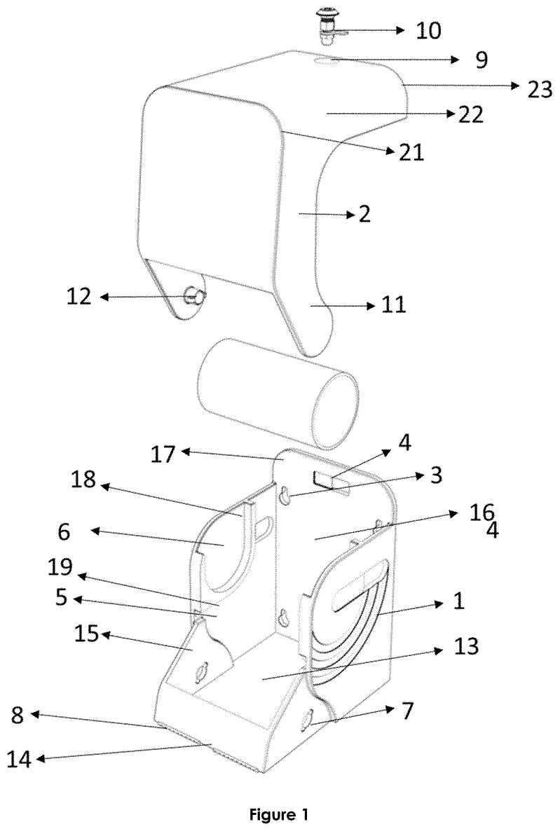

The dispenser of the present invention comprises two parts, a base (1) and a front cover (2), as seen in FIG. 1.

The base comprises at least one mounting grommet (3), useful for fixing the dispenser on the surface of interest, be it a wall or a pole, and which remains firmly attached to said surface to prevent breakage or fall by repeated use. The base also includes an eyelet for securing (4), which will allow the closure of the hinge-type padlock (10), which is located on the front cover (2). The base further comprises side walls (5), on the inside of which it has two U-shaped pieces, here called the tube grip (6), which allows an adhesive tape to be attached and can roll to dispense the plastic material.

In a preferred embodiment, in case the adhesive tape is not coupled to a tube that can be compatible with the gripper (6), it will be provided with a tube that is compatible in shape and size to said gripper (6). A hollow in the pivot (7) is used to couple the base (1) with the front cover (2), which fits perfectly to a pivot (12), which is attached from the inside to the projection (11) of the cover front. The dispenser also comprises at the base (1) a toothed surface for cutting the adhesive tape (8), which can be fixed or extruded with the rest of the plastic piece or separated to be able to be replaced when the part wears out because of everyday use. The front cover (2) comprises an eyelet (9), which serves to fix a padlock (10) to prevent its accidental opening or the removal of the adhesive tape. The shape of the front cover (2) allows the adhesive tape to be protected from the outside and prevents the entry of dust or liquids that could damage the adhesive tape. Thus, the front cover (2) is attached to the base (1) by means of a pivot (12) that is located inside the projection (11) of said cover (2).

The fixed dispenser of the present invention is useful for providing adhesive roll tape, which can be self-adhesive or adhesive and removable.

The dispenser of the present invention is intended to be used in spaces with massive flow of people, such as, but not limited to supermarkets, pharmacies, department stores, airports, means of transportation. The user can adhere the tape to potentially contaminated surfaces when needed, isolate a potentially contaminated surface, therefore facilitating handling without compromising the health of the user.

In this way, the fixed dispenser of the present invention is configured, which will be exemplified below.

### Example

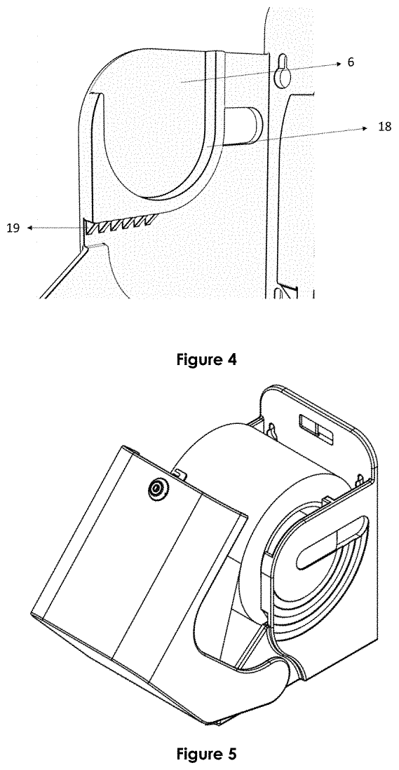

To carry out the invention, the fixed dispenser was designed with dimensions such as to allow a commercial adhesive tape to be dispensed. Reference is made to the parts described in FIGS. 1 to 4.

The dimensions of the base (1) are:

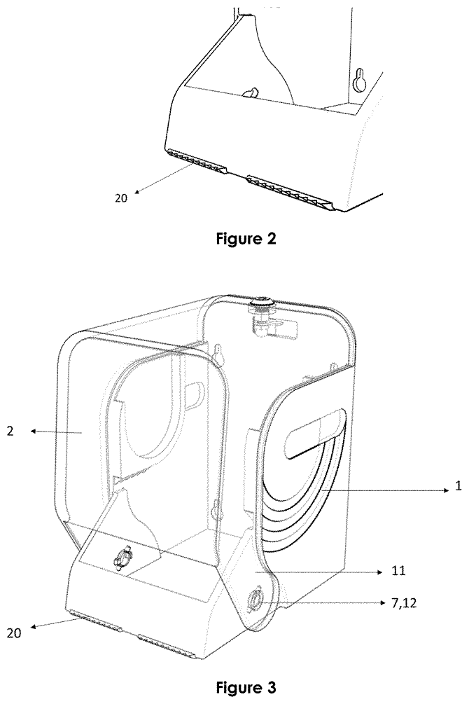

Between 17 and 18 centimeters for the lower surface (13) in its longitudinal configuration, by between 10 and 11 centimeters across the width (14), where the toothed surface (8) is located (see FIG. 2). In turn, this base includes an extruded extension that forms the junction site with the hollow of the pivot (7) which is at an angle of 45° with respect to the base, where the extruded extension has a length of between 8 and 9 centimeters (15). This extension allows adjustment with the front cover (2) in its part (11). Wall (16) of the base (1) has a dimension between 19 and 20 centimeters high, where at the upper end (17) it is curved at the two corners. In the upper central part of the wall (16), there is the securing eye (4) with an approximate length of between 3 and 4 centimeters. The mounting grommets (3) allow the dispenser to be attached to a surface with any conventional fastening means, since they have a height of between 1 and 2 centimeters each.

To configure the piece of the tube gripper (6), the wall (5) has inside a U-shaped notch, which is between 1 and 2 cm wide each (18), and only covers enough space to properly hold the tube of adhesive tape. In order to hold the grip (6) and prevent it from breaking, the piece may comprise small brackets (19), as a preferred embodiment.

In the design, the toothed surface (8) can be at the bottom of the base, or, in a further embodiment the toothed surface can be divided into two parts (20), with a combined length of between 9 and 11 centimeters (compatible with conventional plastic tapes), to allow an efficient and user-friendly cutting of the adhesive tape.

As for the front cover (2), it is made up of a single piece with an external angle of 264° (21), where the upper part of the cover has a length of approximately 14 to 16 cm (22) and a width between 3 and 4 cms (23), and comprises the eyelet for the padlock (9) where the padlock (10) is secured. The front part of the cover (2) measures between 18 and 20 cm, where the pivot (12) is located at the distal end (11), and said distal end fits perfectly with the wall (5) of the base, to avoid separating the pieces when opening the dispenser.

Finally, FIG. 5 shows a preferred embodiment of the fixed dispenser of the present invention in a finished and functional form, which is useful for providing adhesive tape to users who do not wish to be in direct contact with surfaces.

1. An adhesive tape dispenser comprising:
a base (1);
a front cover (2);
wherein the base comprises:
at least one mounting eye (3) adapted to mount the dispenser on a surface such as a wall or a pole;
a securing eyelet (4) to allow a closure of a hinge-type padlock (10), which is located on the front cover (2);
side walls (5) having inside two tube grip pieces (6) having a U-shaped, the two grip pieces are adapted to allow an adhesive tape (8) to be attached to the dispenser and also to roll the adhesive tape to dispense tape;
wherein the dispenser further comprises at the base (1) a toothed surface for cutting the adhesive tape (8).

2. The dispenser according to claim 1, wherein the adhesive tape is not coupled to a tube that is compatible with the gripper (6) and the adhesive tape is provided with a tube that is compatible in a shape and a size to said gripper (6).

3. The dispenser according to claim 1, wherein a hollow in a pivot (7) connects the base (1) to the front cover (2), the base pivots regarding the cover at a pivot (12), which is joined by an internal part to a projection (11) of the front cover.

4. The dispenser according to claim 1, wherein the front cover (2) comprises an eyelet (9) to secure the padlock (10) to prevent its accidental opening or the removal of the adhesive tape.

5. The dispenser according to claim 1, wherein the toothed surface for cutting the adhesive tape (8) is fixed or extruded to the dispenser.

6. The dispenser according to claim 1, wherein the toothed surface for cutting the adhesive tape (20) is separated into two sections of between 9 and 11 centimeters overall.

7. The dispenser according to claim 1, wherein said adhesive tape is auto adherable.

8. The dispenser according to claim 1, wherein said adhesive tape is adherable.
